(19) United States
(12) Patent Application Publication
(10) Pub. No.: US 2026/0225964 A1
(43) Pub. Date: Aug. 6, 2026

(54) SUPERABRASIVE COMPACT SURFACE TREATMENTS, COATINGS, RECLAIMING TECHNIQUES, AND RELATED DEVICES, METHODS, AND SYSTEMS

(71) Applicant: US Synthetic Corporation, Orem, UT (US)

(72) Inventors: Dan Mortensen, Eagle Mountain, UT (US); Daren Heaton, Spanish Fork, UT (US)

(21) Appl. No.: 19/046,472

(22) Filed: Feb. 5, 2025

(51) Int. Cl. C04B 41/53; C04B 37/00; C04B 41/51

(52) U.S. Cl. CPC C04B 41/5353; C04B 37/001; C04B 41/5133; C04B 41/5144; C04B 2237/363

(57) ABSTRACT

A superabrasive compact may include a superabrasive table and a substrate bonded to the superabrasive table, the substrate comprising a pickled exterior surface. A method of reclaiming a superabrasive compact may include depositing the superabrasive compact having a braze material bonded to a surface of the superabrasive compact into an acid bath. The braze material may then be removed from the surface of the superabrasive compact in the acid bath. A method of providing a surface treatment to an unpolished superabrasive compact may include depositing the unpolished superabrasive compact into an acid bath and pickling an exterior surface of a substrate of the unpolished superabrasive compact in the acid bath.

### TECHNICAL FIELD

This application relates to superabrasive compacts, such as polycrystalline diamond compact (“PDC”) cutting elements, surface treatments for superabrasive compacts, surface coatings for superabrasive compacts, reclaiming superabrasive compacts, and related systems and methods.

### BACKGROUND

Wear-resistant, superabrasive compacts may be utilized in a variety of applications. For example, polycrystalline diamond compacts (“PDCs”) are used in drilling tools (e.g., cutting elements, gage trimmers, etc.), machining equipment, bearing apparatuses, wire-drawing machinery, and in other mechanical apparatuses.

PDCs have found particular utility as superabrasive cutting elements in rotary drill bits, such as roller cone drill bits and fixed cutter drill bits. A PDC cutting element typically includes a superabrasive diamond layer commonly referred to as a diamond table.

A fixed-cutter rotary drill bit typically includes a number of PDC cutting elements affixed to the bit body. PDC cutting elements are typically brazed directly into a preformed recess formed in a bit body of a fixed-cutter rotary drill bit. In some applications, the substrate of the PDC cutting element may be brazed or otherwise joined to an attachment member, such as a cylindrical backing, which may be secured to a bit body by press-fitting or brazing.

In use, PDC cutting elements may become worn in a specific area, such as a diamond table region that is positioned radial outward on a drill bit and that engages and cuts material (e.g., a subterranean formation), while other areas of the PDC cutter, such as a diamond table region positioned radially inward on the drill bit that experiences little or no material engagement during drilling operations. In view of this, in order to extend the life of PDC cutters on a drill bit, bit owners may desire to remove the PDC cutting elements from the drill bit and rejoin the PDC cutting elements to the drill bit in a new orientation, such as with worn regions of the PDC cutting elements positioned radially inward on the bit body and less-worn regions positioned radially outward.

Such attempts to reorient PDC cutting elements on a drill bit come with many challenges. For example, when PDC cutting elements are removed from a bit body the PDC cutting elements may be at least partially covered with a layer of braze material, which may need to be removed prior to reattaching the PDC cutter to the bit body.

The braze material may be removed by grinding away the braze material. The grinding, however, may take significant time and effort and result in the PDC cutter becoming undersized for the bit body and/or becoming misshapen (e.g., out-of-round). Additionally, grinding of the PDC cutter may result in a surface that is visually unattractive and/or that may have poor adhesion to newly applied brazing material. To provide a relatively smooth finish to the ground surface, polishing treatments may be conducted on the PDC cutter, but such treatments may be costly and time consuming.

Similarly, manufacturing of new PDC that may require polishing treatments as a final manufacturing step to provide a relatively smooth finish to the body of the cutter.

In view of the foregoing, improvements in reclaiming and finishing superabrasive compacts would be desirable. Additionally, improvements in providing superabrasive compacts with surfaces that are visually attractive and/or that have improved adhesion to brazing materials would be desirable. Furthermore, surface treatments that do not require costly and time-consuming polishing would be desirable.

### SUMMARY

In some aspects, the techniques described herein relate to a method of reclaiming a superabrasive compact, the method including: depositing the superabrasive compact having a braze material bonded to a surface of the superabrasive compact into an acid bath; removing the braze material from the surface of the superabrasive compact in the acid bath; and removing the superabrasive compact from the acid bath.

In some aspects, the techniques described herein relate to a method, wherein removing the braze material from the surface of the superabrasive compact in the acid bath includes removing the braze material from a tungsten carbide substrate surface of the superabrasive compact in the acid bath.

In some aspects, the techniques described herein relate to a method, wherein the superabrasive compact includes a polycrystalline diamond table bonded to a tungsten carbide substrate.

In some aspects, the techniques described herein relate to a method, further including pickling a surface of the tungsten carbide substrate with the acid bath.

In some aspects, the techniques described herein relate to a method, further including plating the surface of the tungsten carbide substrate with a metal after removing the superabrasive compact from the acid bath.

In some aspects, the techniques described herein relate to a method, wherein plating the surface of the tungsten carbide substrate with the metal includes plating the surface of the tungsten carbide substrate with a plating material comprising at least one of nickel, chromium, or cobalt.

In some aspects, the techniques described herein relate to a method, wherein the acid bath includes nitric acid.

In some aspects, the techniques described herein relate to a method, wherein the acid bath further includes hydrochloric acid.

In some aspects, the techniques described herein relate to a method, wherein the acid bath consists essentially of about one part nitric acid and about one part hydrochloric acid.

In some aspects, the techniques described herein relate to a method, wherein the acid bath consists essentially of about one part nitric acid and about three parts hydrochloric acid.

In some aspects, the techniques described herein relate to a method, further including maintaining a temperature of the acid bath above about 45° C.

In some aspects, the techniques described herein relate to a method of providing a surface treatment to an unpolished superabrasive compact, the method including: depositing the unpolished superabrasive compact into an acid bath; pickling an exterior surface of a substrate of the unpolished superabrasive compact in the acid bath to provide a finished superabrasive compact; and removing the finished superabrasive compact from the acid bath.

In some aspects, the techniques described herein relate to a method, further including plating the exterior surface of the substrate with a metal after removing the finished superabrasive compact from the acid bath.

In some aspects, the techniques described herein relate to a method, wherein plating the surface of the substrate with the metal includes plating the surface of the substrate with a plating material comprising at least one of nickel, chromium, or cobalt.

In some aspects, the techniques described herein relate to a method, wherein pickling the exterior surface of the substrate of the unpolished superabrasive compact includes pickling the exterior surface of a tungsten carbide substrate of an unpolished polycrystalline diamond compact.

In some aspects, the techniques described herein relate to a superabrasive compact including: a superabrasive table; and a substrate bonded to the superabrasive table, the substrate including a pickled exterior surface, the pickled exterior surface of the substrate comprising an at least partially etched and microscopically textured surface of a material having been exposed to an acid.

In some aspects, the techniques described herein relate to a superabrasive compact, wherein the superabrasive table includes a polycrystalline diamond table, and the substrate includes a tungsten carbide substrate.

In some aspects, the techniques described herein relate to a superabrasive compact, further including a plating on the pickled exterior surface of the substrate.

In some aspects, the techniques described herein relate to a superabrasive compact, wherein the plating on the pickled exterior surface of the substrate is between about 10 nanometers and about 2 micron thick.

In some aspects, the techniques described herein relate to a superabrasive compact, wherein the plating on the pickled exterior surface of the substrate comprises at least one of nickel, chromium, or cobalt.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a cross-sectional view of a worn superabrasive compact removed from a body of a tool.

FIG. 2 is a chart of a process of reclaiming a superabrasive compact, such as the superabrasive compact of FIG. 1, according to an embodiment of the present disclosure.

FIG. 3 is a cross-sectional view of a superabrasive compact having a substrate with pickled exterior surfaces according to an embodiment of the present disclosure.

FIG. 4A is a schematic illustration and FIG. 4B is a chart of a method to make the superabrasive compact of FIG. 3.

FIG. 5A is an isometric view and FIG. 5B is a top elevation view of an embodiment of a rotary drill bit, according to an embodiment of the present disclosure.

FIG. 6 is an isometric cut-away view of an embodiment of a thrust-bearing apparatus, which may utilize any of the disclosed embodiments, according to an embodiment of the present disclosure.

FIG. 7 is an isometric cut-away view of an embodiment of a radial bearing apparatus, which may utilize any of the disclosed embodiments, according to an embodiment of the present disclosure.

### DETAILED DESCRIPTION

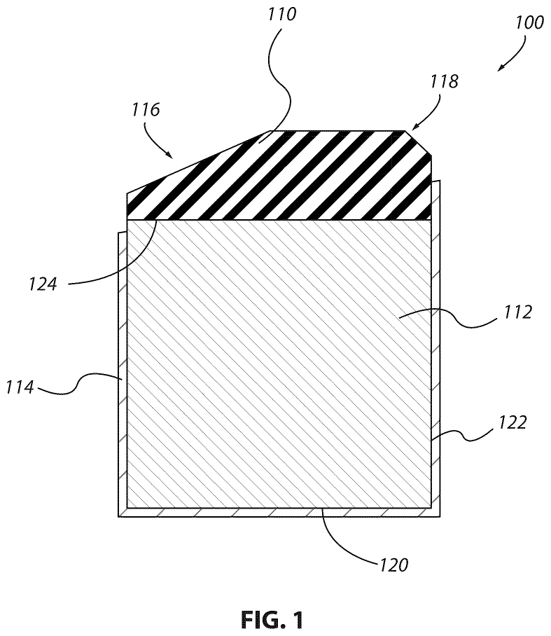

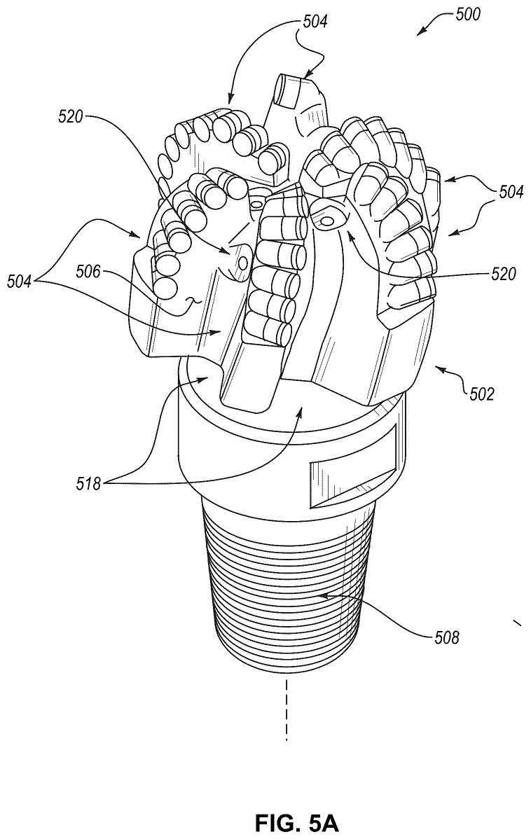

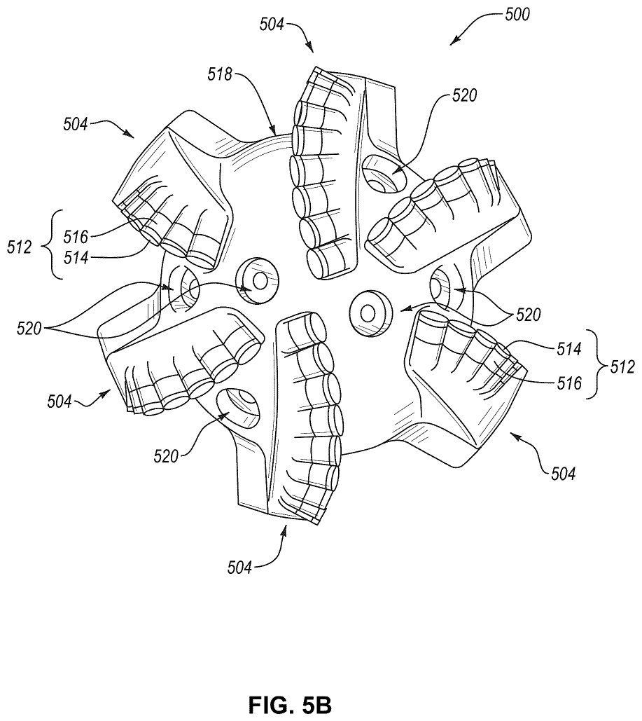

FIG. 1 is a cross-sectional view of a worn superabrasive compact 100 removed from a body of a tool (e.g., a PDC cutter removed from a bit body of an earth-boring rotary drill bit, such as shown in FIG. 5A). As shown, the superabrasive compact 100 includes a superhard material, such as, a polycrystalline diamond (“PCD”) table 110 bonded to a substrate 112. The superabrasive compact 100 includes a braze material 114 adhered to a surface of the substrate 112 and a surface of the PCD table 110, the braze material 114 remaining from the braze material 114 that bonded the superabrasive compact 100 to the tool prior to removal therefrom.

The removal process of the superabrasive compact 100 from a tool may involve heating the tool to a temperature above the melting temperature of the braze material 114 and removing the superabrasive compact 100 from a pocket in the tool while the braze material 114 is melted. Accordingly, a portion of the braze material 114 may remain bonded to the superabrasive compact 100 after the superabrasive compact 100 is removed from the tool. The braze material 114 may be comprised of gold alloys, silver alloys, iron-nickel alloys, or other suitable braze alloys.

The superabrasive compact 100 depicted in FIG. 1 has a cylindrical substrate 112 bonded to the PCD table 110, other superabrasive compacts that may be utilized according to embodiments of the present disclosure, however, may also be of a variety of other shapes. As shown, the substrate 112 includes a substantially planar bottom surface 120, an arcuate side surface 122, and a substantially planar upper surface 124, the substantially planar upper surface 124 being bonded to the PCD table 110.

The substrate 112 may be comprised of any number of materials. For example, the substrate 112 may include, without limitation, cemented carbides, such as tungsten carbide, titanium carbide, chromium carbide, niobium carbide, tantalum carbide, vanadium carbide, or combinations thereof cemented with iron, nickel, cobalt, alloys thereof or combinations thereof. For example, the substrate 112 may include cobalt-cemented tungsten carbide.

After significant use on the tool, the PCD table 110 may become worn and may develop a worn region 116 (e.g., a wear flat) where a portion of the PCD table 110 has been worn away from use. A less worn region 118 of the PCD table 110 (e.g., a portion opposite the wear region 116) may be less worn and/or substantially unworn compared to the worn region 116. Accordingly, it may be desirable for a tool owner to reattach the superabrasive compact 100 to the tool and reorient such that the less worn region 118 of the PCD table 110 is located where the worn region 116 was previously located, thus increasing the life of the tool without the cost of a new superabrasive compact. In order to reorient and reclaim the superabrasive compact 100 and reinsert the superabrasive compact 100 into the pocket of the tool and braze the superabrasive compact 100 thereto, it may be desirable to remove the braze material 114 from the superabrasive compact 100. Additionally, it may be desirable that the superabrasive compact 100 substantially maintain its original dimensions after removal of the braze material 114 to facilitate a secure fit of the superabrasive compact 100 within the pocket.

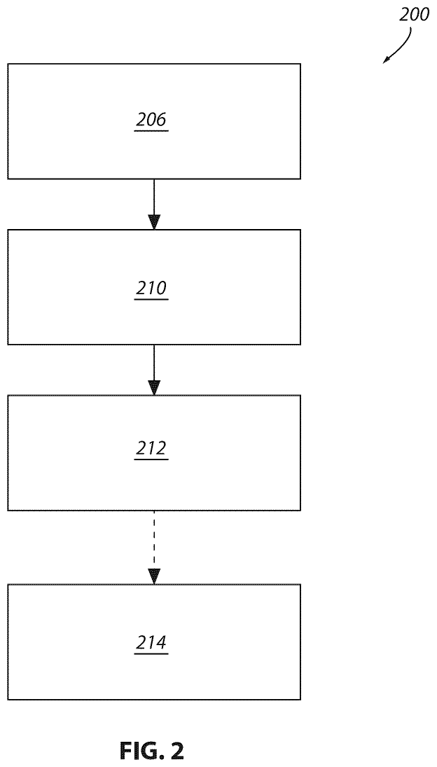

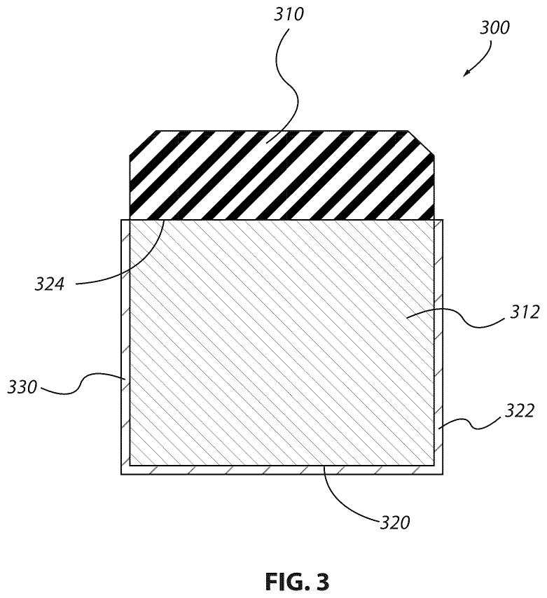

FIG. 2 depicts a process 200 of reclaiming a superabrasive compact, such as the superabrasive compact 100, according to an embodiment of the present disclosure. In act 206, the superabrasive compact 100 may be deposited into an acid bath. In act 210, any braze material 114 present on the superabrasive compact 100 may be removed from the surface of the superabrasive compact 100 in the acid bath, and/or the surface of the substrate 112 exposed to the acid bath has been pickled, as discussed below. In act 212, the superabrasive compact 100 may be removed from the acid bath after the braze material 114 has been removed (e.g., dissolved) from the surface of the superabrasive compact 100 by the acid bath and/or the surface of the substrate 112 exposed to the acid bath has been pickled. Optionally, in act 214, a metal may be plated onto a surface of the substrate 112 of the superabrasive compact 100. For example, a metal may be plated onto the substantially planar bottom surface 120 and the arcuate side surface 122 of the substrate 112 of the superabrasive compact 100. As used herein, the terms “plating”, “plated” and variants thereof means forming, coating, or depositing (and appropriate variants thereof, respectively). For example, plating includes, but is not limited to, electroplating, galvanizing, conversion coating, thermal spraying, chemical vapor deposition, physical vapor deposition, atomic layer deposition, and other suitable methods to form a layer or coating. The phrase “plating material” means any suitable material, composition, or combination of materials which may be used in a plating process.

The acid bath utilized in acts 206, 210, and 212 may be comprised of one or more relatively strong acids that, in addition to removing the braze material 114 from the superabrasive compact 100, may be selected to pickle the exposed surfaces (e.g., the substantially planar bottom surface 120 and arcuate side surface 122) of the substrate 112.

As used herein, the term “pickle” refers to etching the surface of a material to remove a relatively small or minor portion of the surface material and expose underlying material to create a microscopically textured surface.

In some embodiments, the acid bath may comprise at least one of nitric acid, hydrofluoric acid, sulfuric acid, phosphoric acid, hydrobromic acid, hydroiodic acid, perchloric acid, chloric acid, or hydrochloric acid. In some embodiments, the acid bath may comprise a mixture of nitric acid and hydrochloric acid. In some embodiments, the acid bath may consist essentially of a mixture of nitric acid and hydrochloric acid. For example, the acid bath may consist essentially of aqua regia, a mixture of about one part nitric acid and about three parts hydrochloric acid (e.g., a molar ratio of about 1:3). For another example, the acid bath may consist essentially of one of: a mixture of about one part nitric acid and about one part hydrochloric acid (e.g., a molar ratio of about 1:1), a mixture of about one part nitric acid and about two parts hydrochloric acid (e.g., a molar ratio of about 1:2), or a mixture of about one part nitric acid and about four parts hydrochloric acid (e.g., a molar ratio of about 1:4).

Additionally, the acid bath utilized in acts 206, 210, and 212 may be maintained at a specific temperature, or within a specific temperature range, during acts 206, 210, and 212, which may facilitate a predictable and repeatable timeframe within which to perform acts 206, 210, and 212 and achieve a desired result. In some embodiments, the acid bath may be maintained at an elevated temperature greater than ambient or room temperature (e.g., a temperature greater than about 22° C.), as elevating the temperature of the acid bath may reduce the time needed to remove the braze material 114 and pickle the exposed surfaces of the substrate 112. For example, the acid bath may be maintained at a temperature: above about 45° C.; between about 30° C. and about 90° C.; between about 40° C. and about 80° C., between about 40° C. and about 60° C.; or between about 45° C. and about 55° C. For example, the acid bath may be maintained at a temperature of about 50° C. during acts 206, 210, and 212.

In act 206, the superabrasive compact 100 may be deposited into the acid bath so that at least the substrate 112 is submerged in the acid bath. In some embodiments, in act 206 the superabrasive compact 100 may be deposited into the acid bath so that the superabrasive compact 100 is fully submerged in the acid bath.

Optionally, prior to act 206, the superabrasive compact 100 may be ground and resized as a smaller, reconstructed superabrasive compact (e.g., creation of a “new” smaller superabrasive compact). The grinding process to resize the superabrasive compact 100 may leave a relatively coarse surface. Further, finer grinding and polishing to smooth the surface of the superabrasive compact 100 may be performed, if desired. In such embodiments, the resized, reconstructed superabrasive compact 100 may be substantially free of braze material 114, but may benefit from the process 200 to provide a desirable surface finish, as will be discussed in more detail herein below.

In act 210, the superabrasive compact 100 may remain in the acid bath for a period of time during which the braze material 114 may be substantially fully removed from the surface of the superabrasive compact 100 in the acid bath, and/or the exposed surfaces of the substrate 112 may be pickled in the acid bath, but not for so long that a significant amount of material is removed from the substrate 112. For example, the superabrasive compact 100 may remain in the acid bath for a period of time: between about 30 seconds and about 5 minutes; between about 1 minute and about 4 minutes; between about 1 minute and about 3 minutes; or between about 1 minute and about 2 minutes. After the braze material 114 is fully removed from the surface of the superabrasive compact 100 and at least a portion of the surfaces of the substrate 112 exposed to the acid bath are pickled, the superabrasive compact 100 may be removed from the acid bath at act 212.

In some embodiments, the superabrasive compact 100 may be reclaimed and ready for attachment to a tool after the superabrasive compact 100 is removed from the acid bath in act 212. In further embodiments, the superabrasive compact 100 may proceed to act 214 and a metal or metal alloy may be applied at least to a majority of the exterior surfaces of the substrate 112. Prior to plating, the pickled surface of the substrate 112 may have a relatively smooth and uniform appearance. The pickling process may even out the surface of the substrate 112 and remove, or at least make less visible or detectable, grinding markings that may have previously existed. Additionally, the pickling process may give the surface a dull or matte appearance as a result of a microscopic surface texture that is imparted by the acid bath. Many may find the matte surface suitable, and it may be an acceptable finished surface for some customers. Additionally, the surface texture of the substrate 112 imparted by the acid bath may increase the surface area of the exposed surface of the substrate 112, which may provide an improved wetting ability of the surface of the substrate 112 (e.g., compared to a polished surface) when brazing, which may result in a relatively strong bond between the braze material and the substrate 112.

In act 214, the substrate 112 of superabrasive compact 100 may be plated with a metal, such as by electroplating, which may provide several benefits. For example, some consumers may be accustomed to polished and shiny surfaces on superabrasive compacts (e.g., PDCs) and may prefer a shiny surface to the matte surface exhibited by a pickled surface of the substrate 112 of the superabrasive compact 100 after act 212. The surface of the substrate 112 may be polished to make the surface shiny, but polishing may be expensive and time consuming relative to plating and a polished surface may have reduced wetting and/or adhesive properties for brazing. For another example, a plating on the surface of the substrate 112 may provide improved wetting and/or adhesion when compared to a pickled surface for certain brazing materials.

The plating may be relatively thin. For example, the plating may have a thickness: between about 10 nanometers and about 2 microns; between about 15 nanometers and about 1.5 microns; or between about 20 nanometers and about 1 micron.

Electroplating may be utilized to apply a metal plating to the substrate 112. In some embodiments, the electroplating may be conducted at an electric potential of about 3 volts to about 12 volts, a temperature of about 60° C., and for a duration of about 10 seconds to about 2 minutes. Other electric potentials, temperatures, and/or durations may be utilized in additional embodiments selected to apply a relatively uniform metal plating on the substrate 112 in a reasonable amount of time and in conditions as the electroplating equipment may allow. It may be desirable to provide complete and uniform coverage, but additional metal material to increase the plating thickness may not be beneficial and may cause the dimensions to become oversized.

In some embodiments, the substrate 112 of superabrasive compact 100 may be plated with nickel. For example, the substrate 112 of the superabrasive compact 100 may be electroplated with a plating material comprising nickel (e.g., bright nickel), which may provide a mirror-like coating on the substrate 112. As nickel is a component of many brazing materials, the nickel may provide a highly wettable surface for brazing and may melt and dissolve into solution within the brazing alloy during the brazing process (e.g., to attach superabrasive compact 100 to a drill bit) and may provide excellent adhesion between the brazing material and the substrate 112.

In additional embodiments, the substrate 112 of superabrasive compact 100 may be plated with a plating material comprising chromium. For example, the substrate 112 of the superabrasive compact 100 may be electroplated with a chrome plating material, which may provide a mirror-like coating on the substrate 112 that may be desirable for some consumers. In yet additional embodiments, the plating material may include one or more of cobalt, silver, zinc, copper, nickel, tungsten, chromium, or molybdenum.

In yet further embodiments, the substrate 112 of superabrasive compact 100 may be plated with a plating material comprising cobalt or a cobalt-nickel alloy. For example, the substrate 112 of the superabrasive compact 100 may be electroplated with a plating material comprising cobalt-nickel plating, which may provide a shiny and/or mirror-like coating on the substrate 112 that may be desirable for some consumers. For many superabrasive compacts, the substrate 112 may be comprise cobalt-cemented tungsten carbide. Accordingly, cobalt or a cobalt-nickel alloy may provide a highly wettable surface for brazing and may provide enhanced adhesion between the brazing material and the substrate 112.

After act 214, the superabrasive compact 100 may be reclaimed and ready for attachment to a tool.

FIG. 3 shows a cross-sectional view of a superabrasive compact 300 (e.g., a PDC) having a substrate 312 with pickled exterior surfaces 320, 322 according to an embodiment of the present disclosure. Similar to the superabrasive compact 100, the superabrasive compact 300 may include a polycrystalline diamond (“PCD”), or other superhard material, table 310 bonded to the substrate 312 at an interfacial surface 324. The superabrasive compact 300, however, may be newly manufactured and/or may not include any worn regions from use. Optionally, the superabrasive compact 300 may include a plating layer 330 on the exterior surfaces 320, 322 (e.g., an arcuate side surface 322 and a substantially planar bottom surface 320).

In the illustrated embodiment, the superabrasive compact 300 is cylindrical. However, in other embodiments, the superabrasive compact 300 may be non-cylindrical, such as elliptical, rectangular, triangular, or other suitable configuration. Additionally, although the interfacial surface 324 is illustrated as being substantially planar, in other embodiments, the interfacial surface 324 may exhibit a selected nonplanar topography.

The substrate 312 may include, without limitation, cemented carbides, such as tungsten carbide, titanium carbide, chromium carbide, niobium carbide, tantalum carbide, vanadium carbide, or combinations thereof cemented with iron, nickel, cobalt, or alloys thereof. For example, in an embodiment, the substrate 312 comprises cobalt-cemented tungsten carbide.

At least a portion of the exterior surfaces 320, 322 may be pickled and have a microscopic surface texture or other characteristic consistent with pickling. In some embodiments the superabrasive compact 300 may not include a plating layer 330 and the pickled exterior surfaces 320 may exhibit a microscopic texture and exhibit a matte and/or dull finish that is substantially uniform throughout. The surface texture of the substrate 312 imparted by the pickling may increase the surface area of the exposed surface of the substrate 312, which may provide an improved wetting ability of the surface of the substrate 312 (e.g., compared to a polished surface) when brazing resulting in a relatively strong bond between the braze material and the substrate 312.

In further embodiments, the superabrasive compact 300 may include the metal plating layer 330 over the pickled exterior surfaces 320, 322. The metal plating layer 330 may provide improved wetting and/or adhesion when compared to a pickled substrate 312 surface and/or a polished substrate 312 surface for certain brazing materials. The metal plating layer 330 may be relatively thin. For example, the metal plating layer 330 may have a thickness: between about 10 nanometers and about 2 microns; between about 15 nanometers and about 1.5 microns; or between about 20 nanometers and about 1 micron.

In some embodiments, the substrate 312 of the superabrasive compact 300 may be plated with nickel. For example, the substrate 312 of the superabrasive compact 300 may be electroplated with a plating material comprising nickel (e.g., comprising bright nickel plating), which may provide a mirror-like coating on the substrate 312. As nickel is a component of many brazing materials, the nickel may provide a highly wettable surface for brazing and may melt and/or dissolve into solution within the brazing alloy during the brazing process and may provide excellent adhesion between the brazing material and the substrate 312.

In additional embodiments, the substrate 312 of the superabrasive compact 300 may be plated with a plating material comprising chromium. For example, the substrate 312 of the superabrasive compact 300 may be electroplated with a chrome plating material, which may provide a mirror-like coating on the substrate 312 that may be desirable for some consumers.

In yet further embodiments, the substrate 312 of the superabrasive compact 300 may be plated with a plating material comprising cobalt, a metal alloy comprising cobalt, or a cobalt-nickel alloy. For example, the substrate 312 of the superabrasive compact 300 may be electroplated with a cobalt-nickel plating material, which may provide a shiny and/or mirror-like coating on the substrate 312 that may be desirable for some consumers. In some embodiments, the substrate 312 may be cobalt-cemented tungsten carbide. Accordingly, a plating material comprising cobalt or a cobalt-nickel alloy may provide a highly wettable surface for brazing and may provide excellent adhesion between the brazing material and the substrate 312.

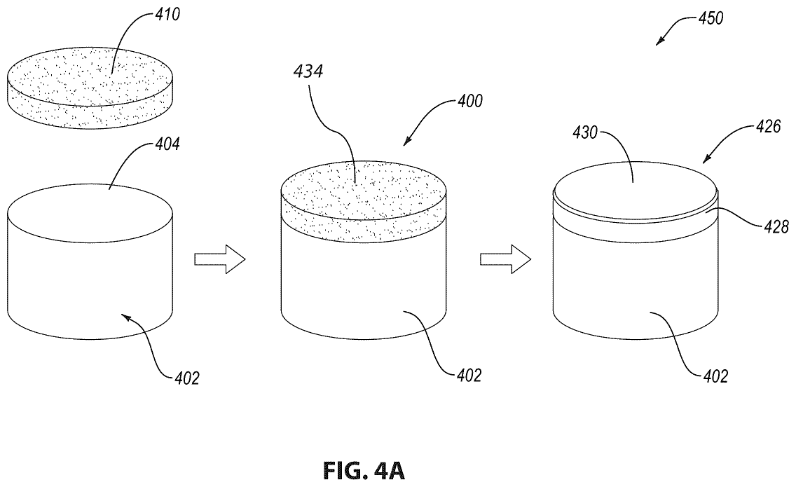

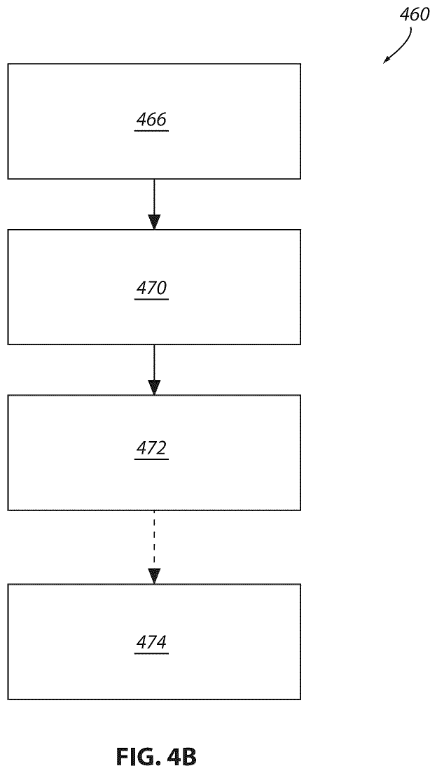

FIGS. 4A and 4B illustrate a method of manufacturing a superabrasive compact, such as the superabrasive compact 300 of FIG. 3, according to an embodiment of the present disclosure.

FIG. 4A is a schematic illustration of a method 450 to form an unpolished superabrasive compact 426, which may be utilized to provide the superabrasive compact 300, in an HPHT process, according to an embodiment of the present disclosure. The method 450 includes disposing a diamond material 410 adjacent to or proximate to an interfacial surface 404 of a substrate 402. The substrate 402 and the diamond material 410 may include any of the substrates and/or diamond materials disclosed herein, respectively. The substrate 402 and the diamond material 410 may be formed into an assembly 400. For example, the substrate 402 and the diamond material 410 may be disposed in a chamber defined by an enclosure (not shown for clarity) and a sealant may also be disposed in the chamber. The assembly 400 may then be hermetically sealed. More details about the formation of such compacts that may be employed are disclosed in U.S. Pat. Nos. 8,236,074 and 8,371,212, each of the disclosures of which is incorporated herein, in its entirety, by this reference.

In some embodiments, the diamond material 410 may include a mass of diamond particles. The mass of diamond particles may exhibit an average particle size of about 50 μm or less, such as about 40 μm or less, about 30 μm, or less, about 20 μm or less, about 10 μm to about 30 μm, about 10 μm to about 20 μm, or about 15 μm to about 18 μm. In some embodiments, the average particle size of the mass of diamond particles may be about 10 μm or less, such as about 2 μm to about 5 μm or submicron.

In some embodiments, the mass of diamond particles may include a relatively larger size and at least one relatively smaller size. As used herein, the phrases “relatively larger” and “relatively smaller” refer to particles sizes (by any suitable method) that differ by at least a factor of two (e.g., 30 μm and 15 μm). According to various embodiments, the mass of diamond particles may include a portion exhibiting a relatively larger size (e.g., 40 μm, 35 μm, 30 μm, 25 μm, 20 μm, 15 μm, 12 μm, 10 μm, 8 μm, 5 μm) and another portion exhibiting at least one relatively smaller size (e.g., 6 μm, 5 μm, 4 μm, 3 μm, 2 μm, 0.75 μm, 1 μm, 0.5 μm, 0.25 μm, less than 0.5 μm, 0.1 μm, less than 0.1 μm). In one embodiment, the diamond particles may include a portion exhibiting a relatively larger size between about 10 μm and about 40 μm and another portion exhibiting a relatively smaller size between about 1 μm and 4 μm. In some embodiments, the diamond particles may comprise three or more different sizes (e.g., one relatively larger size and two or more relatively smaller sizes), without limitation. In other embodiments, the diamond particles may exhibit a single mode or bimodal size distribution (e.g., a single mode or any of the foregoing sizes).

It is noted that the as-sintered diamond grain size may differ from the average particle size of the mass of diamond particles prior to sintering due to a variety of physical processes, such as grain growth, diamond particles fracturing, carbon provided from another carbon source (e.g., dissolved carbon in the metal-solvent catalyst), or combinations of the foregoing.

More details about diamond particle sizes and diamond particle size distributions that may be employed are disclosed in U.S. Pat. Nos. 9,346,149 and 10,501,998. Each of the disclosures of U.S. Pat. Nos. 9,346,149 and 10,501,998 is incorporated herein, in its entirety, by this reference.

In some embodiments, the diamond material 410 includes a preformed PCD table. The preformed PCD table may be formed by disposing an initial mass of diamond particles (e.g., any of the mass of diamond particles disclosed herein) adjacent to an initial substrate. The initial mass of diamond particles and the initial substrate may be disposed in an initial assembly. The initial assembly may be heated to clean the mass of diamond particles, sealed, and then subjected to a first HPHT process (e.g., a temperature greater than 1000° C. and a pressure greater than about 5 GPa or greater than about 7.5 GPa) to sinter the mass of diamond particles into the preformed PCD table. For example, a catalyst (e.g., from the substrate and/or a thin film disposed adjacent to the mass of diamond particles) may sweep into the initial mass of diamond particles to cause diamond-to-diamond bonding and the catalyst may at least partially occupy the interstitial regions between the diamond grains. Examples of sintering the initial mass of diamond particles into a preformed PCD table are disclosed in U.S. Pat. No. 7,866,418 filed on Oct. 3, 2008, the disclosure of which is incorporated herein, in its entirety, by this reference. The preformed PCD table may then be detached from the initial substrate using any suitable method (e.g., the initial substrate may be machined, electro-discharge machined, laser ablated, grinded away, or any suitable material removal method). The preformed PCD table may then be disposed in the assembly 400 as disclosed herein (e.g., replacing the diamond powder). In some embodiments, the preformed PCD table may be leached to remove at least a portion of the catalyst (e.g., metal-solvent catalyst) from the interstitial regions of at least a portion of the PCD table.

The assembly 400 is subjected to an HPHT process using an ultra-high pressure press at a temperature of at least about 1000° C. (e.g., about 1100° C. to about 2200° C. or about 1200° C. to about 1450° C.) and a pressure in the pressure transmitting medium of at least about 4.0 GPa (e.g., about 5.0 GPa to about 12.0 GPa, about 7.5 GPa to about 15 GPa, about 7.5 GPa to about 10 GPa, or about 8.0 GPa to about 10 GPa) for a time sufficient to bond the diamond material 410 to the substrate 402. When the diamond material 410 includes a mass of diamond particles, the HPHT process sinters the diamond particles together in the presence of a catalyst (e.g., metal-solvent catalyst) to form a PCD table 428 comprising bonded diamond grains defining interstitial regions occupied by the catalyst. For example, the pressure in the pressure transmitting medium employed in the HPHT process may be at least at least about 5 GPa, at least about 6 GPa, at least about 7.5 GPa, at least about 8.0 GPa, at least about 9.0 GPa, at least about 10.0 GPa, at least about 11.0 GPa, at least about 12.0 GPa, or at least about 14 GPa.

The pressure values employed in the HPHT processes disclosed herein refer to the pressure in the pressure transmitting medium at room temperature (e.g., about 25° Celsius) with application of pressure using an ultra-high pressure press and not the pressure applied to exterior of a cell assembly. This is known as the “cell pressure.” The actual pressure in the pressure transmitting medium at sintering temperature may be slightly higher. The ultra-high pressure press may be calibrated at room temperature by embedding at least one calibration material that changes structure at a known pressure such as, PbTe, thallium, barium, or bismuth in the pressure transmitting medium. Further, optionally, a change in resistance may be measured across the at least one calibration material due to a phase change thereof. For example, PbTe exhibits a phase change at room temperature at about 6.0 GPa and bismuth exhibits a phase change at room temperature at about 7.7 GPa. Examples of suitable pressure calibration techniques are disclosed in G. Rousse, S. Klotz, A. M. Saitta, J. Rodriguez-Carvajal, M. I. McMahon, B. Couzinet, and M. Mezouar, “Structure of the Intermediate Phase of PbTe at High Pressure,” Physical Review B: Condensed Matter and Materials Physics, 71, 224116 (2005) and D. L. Decker, W. A. Bassett, L. Merrill, H. T. Hall, and J. D. Barnett, “High-Pressure Calibration: A Critical Review,” J. Phys. Chem. Ref. Data, 1, 3 (1972).

During the HPHT process, a catalyst (e.g., cobalt, iron, nickel, alloys thereof, or combinations thereof) may infiltrate the mass of diamond particles 434 and facilitate diamond-to-diamond bonding between the diamond particles. In an embodiment, the catalyst may be provided from the substrate 402. In such an embodiment, the substrate 402 may include a metal-solvent catalyst (e.g., cobalt, nickel, iron, alloys thereof, or combinations thereof). During the HPHT process, the metal-solvent catalyst may liquefy and infiltrate the diamond material 410 to form the PCD table 428 and integrally bond (e.g., a metallurgical bond) the PCD table 428 to the substrate 402. However, it is noted that the catalyst may be provided from a source other than or besides the substrate 402 (e.g., from a metal film disposed between the substrate 402 and diamond material 410, catalyst mixed with the mass of diamond particles, another suitable location, or combinations thereof) and/or the PCD table 428 may be bonded to the substrate 402 using another suitable method (e.g., brazing).

After the HPHT process, the enclosure may be removed from the unpolished superabrasive compact 426. The enclosure may be removed from the unpolished superabrasive compact 426 using any suitable technique. For example, the enclosure may be removed via grit blasting and/or grinding.

In some embodiments, the PCD table 428 may be leached to deplete a metal-solvent catalyst or a metallic infiltrant therefrom to enhance the thermal stability of the PCD table 428. For example, the PCD table 428 may be leached to remove at least a portion of the metal-solvent catalyst from a working region thereof to a selected depth that was used to initially sinter the diamond grains to form a leached thermally-stable region. The leached thermally-stable region may extend inwardly from a working surface of the PCD table 428 to a selected depth. In an embodiment, the depth of the thermally-stable region may be about 10 μm to about 1500 μm. In an embodiment, the selected depth is: about 50 μm to about 100 μm; about 200 μm to about 450 μm; about 450 μm to about 600 μm; about 400 μm to about 800 μm; about 800 μm to about 1500 μm; or greater than 1500 μm. The leaching may be performed in a suitable acid, such as aqua regia, nitric acid, hydrofluoric acid, or mixtures of the foregoing.

In some embodiments, after forming the PCD table 428, at least a portion of the unpolished superabrasive compact 426 may be subjected to post-HPHT shaping processes (e.g., machined, leached, etc.) to at least one of change a shape, composition, or dimension of the unpolished superabrasive compact 426 (e.g., change an outside diameter of the unpolished superabrasive compact 426), remove undesired geometry flaws from the unpolished superabrasive compact 426 (e.g., flatten a concave top surface 430 of the PCD table 428 formed via warping), shape the PCD table 428 (e.g., form a chamfer in the PCD table 428), and/or polish the PCD table 428. The unpolished superabrasive compact 426 may be shaped using any suitable technique. For example, the unpolished superabrasive compact 426 may be shaped by laser ablation techniques, centerless grinding, lapping, electro-discharge machining, or any suitable machining technique. The unpolished superabrasive compact 426 may be shaped either before and/or after leaching the PCD table 428.

The unpolished superabrasive compact 426 may then be subject to a process 460, similar to the process 200 described with reference to FIG. 2, to provide the superabrasive compact 300.

FIG. 4B depicts the process 460 of providing a surface treatment to the substrate 402 of the unpolished superabrasive compact 426 to provide the superabrasive compact 300, according to an embodiment of the present disclosure. In act 466, the superabrasive compact 100 may be deposited into an acid bath. In act 470, the surface of the substrate 402 exposed to the acid bath may be pickled. In act 472, the unpolished superabrasive compact 426 may be removed from the acid bath after the surface of the substrate 402 exposed to the acid bath has been pickled to provide the superabrasive compact 300. Optionally, in act 474, a plating material comprising metal may be plated onto a surface of the substrate of the superabrasive compact 300.

The acid bath utilized in acts 466, 470, and 472 may be comprised of one or more relatively strong acids that may be selected to pickle the exposed surfaces of the substrate 402. In some embodiments, the acid bath may comprise at least one of nitric acid, hydrofluoric acid, sulfuric acid, phosphoric acid, hydrobromic acid, hydroiodic acid, perchloric acid, chloric acid, or hydrochloric acid. In some embodiments, the acid bath may comprise a mixture of nitric acid and hydrochloric acid. In some embodiments, the acid bath may consist essentially of a mixture of nitric acid and hydrochloric acid. For example, the acid bath may consist essentially of aqua regia, a mixture of about one part nitric acid and about three parts hydrochloric acid (e.g., a molar ratio of about 1:3). For another example, the acid bath may consist essentially of one of: a mixture of about one part nitric acid and about one part hydrochloric acid (e.g., a molar ratio of about 1:1); a mixture of about one part nitric acid and about two parts hydrochloric acid (e.g., a molar ratio of about 1:2); or a mixture of about one part nitric acid and about four parts hydrochloric acid (e.g., a molar ratio of about 1:4).

Additionally, the acid bath utilized in acts 466, 470, and 472 may be maintained at a specific temperature, or within a specific temperature range, during acts 466, 470, and 472, which may facilitate a predictable and repeatable timeframe within which to perform acts 466, 470, and 472 and achieve a desired result. In some embodiments, the acid bath may be maintained at an elevated temperature greater than ambient or room temperature (e.g., a temperature greater than about 22° C.), as elevating the temperature of the acid bath may reduce the time needed to pickle the exposed surfaces of the substrate 402. For example, the acid bath may be maintained at a temperature: above about 45° C; between about 30° C. and about 90° C.; between about 40° C. and about 80° C.; between about 40° C. and about 60° C.; or between about 45° C. and about 55° C. For example, the acid bath may be maintained at a temperature of about 50° C. during acts 466, 470, and 472.

In act 466, the unpolished superabrasive compact 426 may be positioned into the acid bath (or otherwise exposed) so that at least the substrate 402 is submerged in the acid bath. In some embodiments, in act 466 the unpolished superabrasive compact 426 may be positioned in the acid bath so that the unpolished superabrasive compact 426 is fully submerged (or otherwise fully exposed) in the acid bath.

In act 470, the unpolished superabrasive compact 426 may remain in the acid bath for a selected period of time during which the exposed surfaces of the substrate 402 may be pickled in the acid bath, but not for so long that a significant amount of material is removed from the substrate 402, to provide a finished superabrasive compact, such as the superabrasive compact 300. For example, the unpolished superabrasive compact 426 may remain in the acid bath for a period of time: between about 30 seconds and about 5 minutes; between about 1 minute and about 4 minutes; between about 1 minute and about 3 minutes; or between about 1 minute and about 2 minutes. After the surfaces of the substrate 402 exposed to the acid bath are pickled, the finished superabrasive compact may be removed from the acid bath at act 472, such as to provide the superabrasive compact 300 (see FIG. 3) with at least a pickled portion of a surface of substrate 312.

In some embodiments, the pickling process may include an electrolytic pickling and/or removal of a metallic material (e.g., cobalt) from the substrate using a voltage potential and a solution. The solution may include a buffered or a non-buffered electrolyte solution (e.g., an electrolyte solution including compound amines, amino acids, citric acids, or other carboxylic acids) as the counterions used in the pickling. In some embodiments, the solution may include acetic acid, ammonium chloride, arsenic acid, ascorbic acid, citric acid, formic acid, hydrobromic acid, hydrofluoric acid, hydroiodic acid, lactic acid, malic acid, nitric acid, oxalic acid, phosphoric acid, propionic acid, pyruvic acid, succinic acid, tartaric acid, glycine, aspartic acid, glutamic acid, histidine, aniline, ethanolamine, and/or any suitable acid or solution (e.g., monocarboxylic acid, polycarboxylic acid, etc.).

Such an electrolytic pickling and/or removal of cobalt from the substrate may include similar features and/or characteristics to the processes described above.

In the electrolytic pickling and/or removal of cobalt from the substrate, a positive charge may be placed on the part or material and a negative charge is placed in the leaching or pickling solution.

The leaching or pickling solution may contain around 0.29 M citric acid or other acid or solution at 3 pH to 9 pH (e.g., 6 to 9 pH, 4 to 7 pH, etc.). In other embodiments, the citric acid may be present in the electrolyte solution in a molarity of 0.01 M or greater, such as about 0.01 M to about 0.05 M, about 0.15 M to about 1 M, about 0.2 M, about 0.3M, about 0.5M, etc.

In some embodiments, the leaching or pickling solution may contain Co, Ni, Fe, Mn, Mg, Ca, other metal ions, or combinations thereof.

The voltage potential provided may be around 0.1 volts to 6 volts. For example, a voltage of approximately 0.1 V, 0.2 V, 0.3 V, 0.4 V, 0.5 V, 0.6 V, 0.7 V, 0.8 V, 0.9 V, 1.0 V, or greater may be applied to processing solution. In some embodiments, the pickling bath may be heated. As above, the part or material is removed from the pickling bath after a desired pickling is achieved.

The pickled portion of the substrate 312 may have a relatively smooth and uniform appearance. The pickling process may even out the portion of a surface of the substrate 312 and remove, or at least make less visible, grinding markings that may have previously existed on the unpolished superabrasive compact 426. Additionally, the pickling process may give the surface a relatively dull or matte appearance as a result of a microscopic surface texture that is imparted by the acid bath. Many may find the matte surface attractive and it may be an acceptable finished surface for some customers. Additionally, the surface texture of the substrate 312 imparted by the acid bath may increase the surface area of the exposed surface of the substrate 312, which may provide an improved wetting ability of the surface of the substrate 312 (e.g., compared to a polished surface) when brazing, resulting in a relatively strong bond between the braze material and the substrate 312.

In some embodiments, the superabrasive compact 300 may be finished and ready for attachment to a tool after removal of the unpolished superabrasive compact 426 from the acid bath in act 472. In further embodiments, the superabrasive compact 300 may proceed to act 474 and a metal plating may be applied to the exterior surfaces of the substrate 312.

In act 474, the substrate 312 of the superabrasive compact 300 may be plated with a metal, such as by electroplating, which may provide several benefits. For example, some consumers may be accustomed to polished and shiny surfaces on superabrasive compacts and may prefer a shiny surface to the matte surface exhibited by a pickled surface of the substrate 312 of the superabrasive compact 300 after act 472. The surface of the substrate 312 may be polished to make the surface shiny, but polishing may be expensive and time consuming relative to plating and a polished surface may have reduced wetting and/or adhesive properties for brazing. For another example, a plating on the surface of the substrate 312 may provide improved wetting and/or adhesion when compared to a pickled surface for certain brazing materials.

The metal plating may be relatively thin. For example, the metal plating may have a thickness: between about 10 nanometers and about 2 microns; between about 15 nanometers and about 1.5 microns; or between about 20 nanometers and about 1 micron.

Electroplating may be utilized to apply a metal plating to the substrate 312. In some embodiments, the electroplating may be conducted at an electric potential of about 3 volts to about 12 volts, a temperature of about 60° C., and for a duration of about 10 seconds to about 2 minutes. Other electric potentials, temperatures, and/or durations may be utilized in additional embodiments selected to apply a relatively uniform metal plating on the substrate 312 in a reasonable amount of time and in conditions as the electroplating equipment may allow. It may be desirable to provide complete and uniform coverage, but additional metal material to increase the plating thickness may not be beneficial.

In some embodiments, the substrate 312 of superabrasive compact 300 may be plated with a plating material comprising nickel. For example, the substrate 312 of superabrasive compact 300 may be electroplated with a bright nickel plating material, which may provide a mirror-like coating on the substrate 312. As nickel is a component of many brazing materials, the nickel may provide a highly wettable surface for brazing and/or may melt and/or dissolve into solution within the brazing alloy during the brazing process, which may provide excellent adhesion between the brazing material and the substrate 312.

In additional embodiments, the substrate 312 of superabrasive compact 300 may be plated with a plating material comprising chromium. For example, the substrate 312 of superabrasive compact 300 may be electroplated with a chrome plating material, which may provide a mirror-like coating on the substrate 312 that may be desirable.

In yet further embodiments, the substrate 312 of superabrasive compact 300 may be plated with a plating material comprising cobalt or a plating material comprising a cobalt-nickel alloy. For example, the substrate 312 of superabrasive compact 300 may be electroplated with a cobalt-nickel plating material, which may provide a shiny and/or mirror-like coating on the substrate 312 that may be desirable for some consumers. In some embodiments, the substrate 312 may be a cobalt-cemented tungsten carbide material. Accordingly, cobalt or a cobalt-nickel alloy may provide a highly wettable surface for brazing and may provide excellent adhesion between the brazing material and the substrate 312.

After act 474, the superabrasive compact 300 may be finished and ready for attachment to a tool.

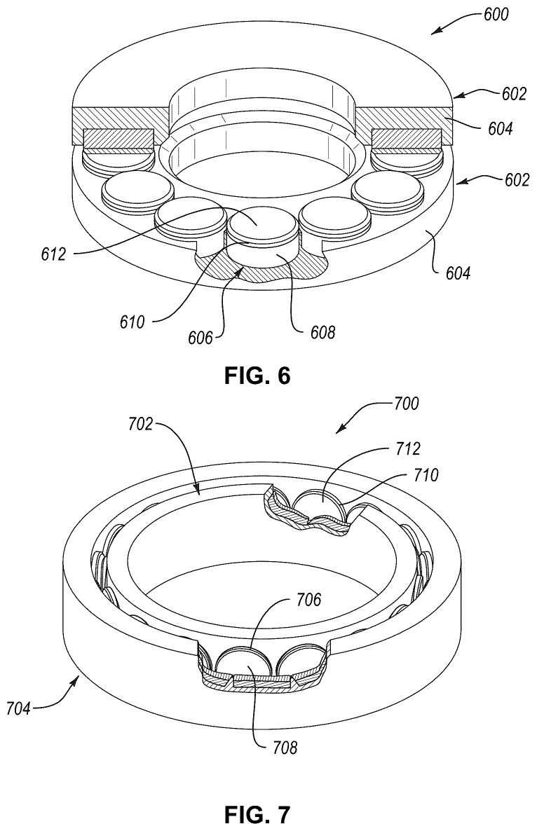

The disclosed reclaimed superabrasive compact 100 and the superabrasive compact 300 embodiments may be used in many applications including, but not limited to, use in a rotary drill bit (FIGS. 5A and 5B), a thrust-bearing apparatus (FIG. 6), a radial bearing apparatus (FIG. 7), a subterranean drilling system, and/or a wire-drawing die. The various applications discussed above are merely some examples of applications in which the reclaimed superabrasive compact 100 and the superabrasive compact 300 embodiments may be used. Other applications are contemplated, such as employing the disclosed reclaimed superabrasive compact 100 and the superabrasive compact 300 embodiments in friction stir welding tools.

FIG. 5A is an isometric view and FIG. 5B is a top elevation view of an embodiment of a rotary drill bit 500, according to an embodiment. The rotary drill bit 500 includes at least one superabrasive compact with a substrate surface configured according to any of the previously described embodiments. The rotary drill bit 500 comprises a bit body 502 that includes radially and longitudinally extending blades 504 with leading faces 506, and a threaded pin connection 508 for connecting the bit body 502 to a drilling string. The bit body 502 defines a leading end structure for drilling into a subterranean formation by rotation about a longitudinal axis 510 and application of weight-on-bit. At least one superabrasive compact cutting element (e.g., at least one PDC cutting element), configured according to any of the previously described superabrasive compact embodiments (e.g., the superabrasive compact 300 shown in FIG. 3), may be affixed to the bit body 502. With reference to FIG. 5B, a plurality of superabrasive compacts 512 are secured to the blades 504. For example, each superabrasive compact 512 may include a PCD table 514 bonded to a substrate 516. More generally, one or more of the superabrasive compacts 512 may comprise any superabrasive compact element(s) disclosed herein, without limitation. In addition, if desired, in some embodiments, a number of the superabrasive compacts 512 may be conventional in construction. Also, circumferentially adjacent blades 504 define so-called junk slots 518 therebetween, as known in the art. Additionally, the rotary drill bit 500 may include a plurality of nozzle cavities 520 for communicating drilling fluid from the interior of the rotary drill bit 500 to the superabrasive compacts 512.

FIGS. 5A and 5B merely depict an embodiment of a rotary drill bit 500 that employs at least one cutting element comprising a superabrasive compact fabricated and/or structured in accordance with any embodiment disclosed herein, without limitation. The rotary drill bit 500 may represent any number of earth-boring tools or drilling tools, including, for example, core bits, roller-cone bits, fixed-cutter bits, eccentric bits, bicenter bits, reamers, reamer wings, or any other downhole tool including superabrasive compacts, without limitation.

FIG. 6 is an isometric cut-away view of an embodiment of a thrust-bearing apparatus 600, which may utilize any of the disclosed embodiments (e.g., included the superabrasive compact 300 shown in FIG. 3), according to an embodiment. The thrust-bearing apparatus 600 includes respective thrust-bearing assemblies 602. Each thrust-bearing assembly 602 includes a support ring 604 that may be fabricated from a material, such as carbon steel, stainless steel, or another suitable material. Each support ring 604 includes a plurality of recesses (not labeled) that receives a corresponding bearing element 606. Each bearing element 606 may be mounted to a corresponding support ring 604 within a corresponding recess by brazing, press-fitting, using fasteners, or another suitable mounting technique. One or more, or all of bearing elements 606 may be configured according to any of the disclosed embodiments. For example, each bearing element 606 may include a shaped substrate 608 and a PCD table 610, with the PCD table 610 including a bearing surface 612.

In use, the bearing surfaces 612 of one of the thrust-bearing assemblies 602 bears against the opposing bearing surfaces 612 of the other one of the bearing assemblies 602. For example, one of the thrust-bearing assemblies 602 may be operably coupled to a shaft to rotate therewith and may be termed a “rotor.” In such an example, the other one of the thrust-bearing assemblies 602 may be held stationary and may be termed a “stator.”

FIG. 7 is an isometric cut-away view of an embodiment of a radial bearing apparatus 700, which may utilize any of the disclosed embodiments, according to an embodiment. The radial bearing apparatus 700 includes an inner race 702 positioned generally within an outer race 704. The outer race 704 includes a plurality of bearing elements 706 affixed thereto that have respective bearing surfaces 708. The inner race 702 also includes a plurality of bearing elements 710 affixed thereto that have respective bearing surfaces 712. One or more, or all of the bearing elements 706 and 710 may be configured according to any of the superabrasive compact embodiments disclosed herein. The inner race 702 is positioned generally within the outer race 704 and, thus, the inner race 702 and outer race 704 may be configured so that the bearing surfaces 708 and 712 may at least partially contact one another and move relative to each other as the inner race 702 and outer race 704 rotate relative to each other during use.

The radial-bearing apparatus 700 may be employed in a variety of mechanical applications. For example, so-called “roller cone” rotary drill bits may benefit from a radial-bearing apparatus disclosed herein. More specifically, the inner race 702 may be mounted to a spindle of a roller cone and the outer race 704 may be mounted to an inner bore formed within a cone and that such an outer race 704 and inner race 702 may be assembled to form a radial-bearing apparatus.

While various aspects and embodiments have been disclosed herein, other aspects and embodiments are contemplated. The various aspects and embodiments disclosed herein are for purposes of illustration and are not intended to be limiting.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall have the same meaning as the word “comprising” and variants thereof (e.g., “comprise” and “comprises”). Terms of degree (e.g., “about,” “substantially,” “generally,” etc.) indicate structurally or functionally insignificant variations. In an example, when the term of degree is included with a term indicating quantity, the term of degree is interpreted to mean±10%, ±5%, ±2%, or even ±0% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

What is claimed is:

1. A method of reclaiming a superabrasive compact, the method comprising:
depositing the superabrasive compact having a braze material bonded to a surface of the superabrasive compact into an acid bath;
removing the braze material from the surface of the superabrasive compact in the acid bath; and
removing the superabrasive compact from the acid bath.

2. The method of claim 1, wherein removing the braze material from the surface of the superabrasive compact in the acid bath comprises removing the braze material from a tungsten carbide substrate surface of the superabrasive compact in the acid bath.

3. The method of claim 2, wherein the superabrasive compact comprises a polycrystalline diamond table bonded to a tungsten carbide substrate.

4. The method of claim 3, further comprising pickling a surface of the tungsten carbide substrate with the acid bath.

5. The method of claim 4, further comprising plating the surface of the tungsten carbide substrate with a metal after removing the superabrasive compact from the acid bath.

6. The method of claim 5, wherein plating the surface of the tungsten carbide substrate with the metal comprises plating the surface of the tungsten carbide substrate with one of bright nickel, chromium, or cobalt.

7. The method of claim 1, wherein the acid bath comprises nitric acid.

8. The method of claim 7, wherein the acid bath further comprises hydrochloric acid.

9. The method of claim 8, wherein the acid bath consists essentially of about one part nitric acid and about one part hydrochloric acid.

10. The method of claim 8, wherein the acid bath consists essentially of about one part nitric acid and about three parts hydrochloric acid.

11. The method of claim 8, further comprising maintaining a temperature of the acid bath above about 45° C.

12. A method of providing a surface treatment to an unpolished superabrasive compact, the method comprising:
depositing the unpolished superabrasive compact into an acid bath;
pickling an exterior surface of a substrate of the unpolished superabrasive compact in the acid bath to provide a finished superabrasive compact; and
removing the finished superabrasive compact from the acid bath.

13. The method of claim 12, further comprising plating the exterior surface of the substrate with a metal after removing the finished superabrasive compact from the acid bath.

14. The method of claim 13, wherein plating the exterior surface of the substrate with the metal comprises plating the exterior surface of the substrate with one of bright nickel, chromium, or cobalt.

15. The method of claim 12, wherein pickling the exterior surface of the substrate of the unpolished superabrasive compact comprises pickling the exterior surface of a tungsten carbide substrate of an unpolished polycrystalline diamond compact.

16. A superabrasive compact comprising:
a superabrasive table; and
a substrate bonded to the superabrasive table, the substrate comprising a pickled exterior surface, the pickled exterior surface of the substrate comprising an at least partially etched and microscopically textured surface of a material having been exposed to an acid.

17. The superabrasive compact of claim 16, wherein the superabrasive table comprises a polycrystalline diamond table, and the substrate comprises a tungsten carbide substrate.

18. The superabrasive compact of claim 16, further comprising a metal plating on the pickled exterior surface of the substrate.

19. The superabrasive compact of claim 18, wherein the metal plating on the pickled exterior surface of the substrate is between about 10 nanometers and about 2 micron thick.

20. The superabrasive compact of claim 18, wherein the metal plating on the pickled exterior surface of the substrate is one of bright nickel, chromium, or cobalt.
